(19) United States
(12) Patent Application Publication
(10) Pub. No.: US 2026/0357371 A1
(43) Pub. Date: Nov. 12, 2026

(54) Method for Stepwise Extraction of Iron and Aluminum from Wet-Process Phosphoric Acid

(71) Applicant: Institute of Process Engineering Chinese Academy of Sciences, Beijing (CN)

(72) Inventors: Ganyu ZHU, Beijing (CN); Huiquan LI, Beijing (CN); Yue YANG, Beijing (CN); Junsheng ZHOU, Beijing (CN); Ziheng MENG, Beijing (CN); Kun YAN, Beijing (CN); Wenjuan ZHANG, Beijing (CN)

(73) Assignee: Institute of Process Engineering Chinese Academy of Sciences, Beijing (CN)

(21) Appl. No.: 19/368,173

(22) Filed: Oct. 24, 2025

(30) Foreign Application Priority Data
Oct. 24, 2024 (CN) 202411491626.7

(51) Int. Cl. C22B 3/40; C22B 21/00

(52) U.S. Cl. CPC C22B 3/40; C22B 21/0015

(57) ABSTRACT

The present application relates to a method for stepwise extraction of iron and aluminum from wet-process phosphoric acid, and the method comprises the following steps: mixing a first extraction system with wet-process phosphoric acid in a volume ratio of 1:(1-6), and performing a first extraction to obtain an iron-removed phosphoric acid; and then mixing a second extraction system with the iron-removed phosphoric acid of step (1) in a volume ratio of (1.2-6):1, and performing a second extraction to obtain a highly purified phosphoric acid; wherein the first extraction system and the second extraction system each independently comprise an extractant containing phosphorus-oxygen double bonds and/or an extractant containing phosphorus-hydroxyl groups. By using the method, the extraction rate of iron ions can be 99% or more, and the extraction rate of aluminum ions can be 88% or more.

### CROSS-REFERENCE TO RELATED APPLICATION(S)

This application claims priority to Chinese Patent Application No. 202411491626.7 filed on Oct. 24, 2024, the disclosure of which is incorporated herein by reference in its entirety.

### TECHNICAL FIELD

The present application relates to the technical field of resources and environment, and specifically relates to a method for stepwise extraction of iron and aluminum from wet-process phosphoric acid.

### BACKGROUND

Phosphoric acid is an important product in the phosphorus chemical industry and an important chemical raw material in industrial production. It can be used to prepare chemical fertilizers, detergents, food and feed additives, etc. Due to the advantages of low cost and low energy consumption, the wet phosphoric acid process has become the mainstream process for preparing phosphoric acid from phosphate rock in the current. However, wet-process phosphoric acid often contains a variety of impurities, such as metal ions like iron ions and aluminum ions. These impurities not only affect product quality and hinder the back-end application of the product, but also damage the production equipment and environment. Therefore, analysis and treatment of impurities in wet-process phosphoric acid are very important.

At present, the industrial methods for purifying wet-process phosphoric acid mainly include crystallization, ion exchange, solvent precipitation, organic solvent extraction, purification by concentration, and electrodialysis. The solvent extraction method for purifying wet-process phosphoric acid has become the mainstream method for purifying and removing impurities in wet-process phosphoric acid due to its advantages of good separation efficacy, low raw material consumption, and low energy consumption for impurity removal. Despite extensive research on impurity removal of wet-process phosphoric acid, the efficient separation and selective recovery of iron and aluminum ions with similar chemical properties from wet-process phosphoric acid have not been achieved.

For example, CN110116997A discloses a method for removal of iron from wet-process phosphoric acid. For this method, hydrogen peroxide is first used to oxidize the ferrous ions of crude phosphoric acid into ferric ions, and then tributyl phosphate and kerosene are used to perform multi-stage extraction and stripping, and finally, the removal of iron-ion impurity is achieved. This method has a complex extraction process and high equipment requirements, and aluminum ions of similar chemical properties as iron ions are not further removed, failing to achieve efficient separation and recovery of aluminum-ion impurity in wet-process phosphoric acid.

CN101920946B discloses a method for reducing iron and aluminum ions in wet-process phosphoric acid. The method is to first subject the wet-process phosphoric acid to oxidation treatment with hydrogen peroxide, and then add potassium oxalate and sodium carbonate to the oxidized wet-process phosphoric acid to perform chemical reaction treatment, thereby partially removing iron and aluminum ions from the wet-process phosphoric acid. By this method, iron and aluminum ions are partially removed at the same time from wet-process phosphoric acid; efficient separation and recycling of iron ions and aluminum ions are not achieved, and the maximum iron ion removal rate is only 70%.

Therefore, how to efficiently separate and selectively, individually recycle iron and aluminum ions of similar chemical properties from wet-process phosphoric acid has become an urgent problem to be solved at present.

### SUMMARY

To solve the above technical problem, the method of the present application first extracts iron from wet-process phosphoric acid at a lower O/A ratio, then adjusts the O/A ratio, and further extracts aluminum at a higher O/A ratio. The iron and aluminum in wet-process phosphoric acid can be extracted stepwise, thereby achieving efficient separation and selective recovery of iron and aluminum from wet-process phosphoric acid, and improving the comprehensive utilization of wet-process phosphoric acid, and the method has the advantages of simple process flow, low cost, no secondary pollution, and easy industrialization.

To achieve the above purpose, the present application adopts the technical solutions below.

The present application provides a method for stepwise extraction of iron and aluminum from wet-process phosphoric acid, and the method comprises the following steps:
(1) mixing a first extraction system with wet-process phosphoric acid in a volume ratio of 1:(1-6), and performing a first extraction to obtain an iron-removed phosphoric acid; and
(2) mixing a second extraction system with the iron-removed phosphoric acid of step (1) in a volume ratio of (1.2-6):1, and performing a second extraction to obtain highly purified phosphoric acid;
wherein the first extraction system and the second extraction system each independently comprise an extractant containing phosphorus-oxygen double bonds and/or an extractant containing phosphorus-hydroxyl groups.

For the method, in step (1), a volume ratio of the first extraction system to the wet-process phosphoric acid is 1:(1-6), which may be, for example, 1:1, 1:1.5, 1:2, 1:2.5, 1:3, 1:3.5, 1:4, 1:4.5, 1:5, 1:5.5, or 1:6.

In step (2), a volume ratio of the second extraction system to the iron-removed phosphoric acid of step (1) is (1.2-6):1, which may be, for example, 1.2:1, 1.5:1, 2:1, 2.5:1, 3:1, 3.5:1, 4:1, 5:1, or 6:1.

In the present application, iron and aluminum are stepwise extracted from wet-process phosphoric acid via adjusting the O/A ratio, iron ions in the wet-process phosphoric acid are first extracted under an O/A ratio of 1:(1-6) to obtain the iron-removed phosphoric acid, and then aluminum ions in the iron-removed phosphoric acid are extracted under an O/A ratio of (1.2-6):1 to obtain the highly purified phosphoric acid. The method solves the technical problem that, with similar properties, iron ions and aluminum ions in wet-process phosphoric acid are difficult to separate and individually recover, laying a foundation for the subsequent high-quality utilization of the highly purified phosphoric acid, and the method has a simple process flow, low cost, and good industrialization feasibility.

It is worth noting that, in the present application, there exists competition between iron ions and aluminum ions when extracted by the first extraction system and the second extraction system. Iron ions have an advantage position in the competition due to their stronger complexing ability. The extraction systems are more inclined to chemically react with iron ions to form stable complexes, while the extraction of aluminum ions is relatively weak. Such selectivity determines that under the same O/A ratio conditions, the extraction rate of iron is higher, and a high extraction efficiency can be realized at a low O/A ratio.

In the present application, the first extraction system and the second extraction system each independently comprise an extractant containing phosphorus-oxygen double bonds and/or an extractant containing phosphorus-hydroxyl groups. The P═O and P—OH bonds in the extractant are used to coordinate with iron ions and aluminum ions and form stable complexes. Due to the existence of the P═O bond, the extractant has certain acidity, and such acidity enables the extractant to undergo an exchange reaction with metal cations (such as iron ions and aluminum ions) in the aqueous phase. The stronger the acidity, the greater the ability to extract iron ions and aluminum ions. In addition, the oxygen atom in the P═O bond has strong electrophilicity and can attract metal cations to form a stable complex, thereby realizing extraction; the hydrogen ion in the P—OH bond can form hydrogen bonds with water molecules or other oxygen-containing groups, which facilitates the extractant dispersing and contacting with iron ions and aluminum ions in the aqueous phase; at the same time, the hydrogen ions exchange with anions in the aqueous phase, so that the iron ions and aluminum ions can be transferred from the aqueous phase to the organic phase to achieve extraction separation.

It is worth noting that in the present application, the first extraction system and the second extraction system may be the same or not, and are each independently selected from an extractant containing phosphorus-oxygen double bonds and/or an extractant containing phosphorus-hydroxyl groups.

Preferably, in step (1), the volume ratio of the first extraction system to the wet-process phosphoric acid is 1:(1-3).

Preferably, in step (2), the volume ratio of the second extraction system to the iron-removed phosphoric acid of step (1) is (4-6):1.

It is worth noting that in the present application, further preferably, the volume ratio of the first extraction system to the wet-process phosphoric acid in step (1) is 1:(1-3), and the volume ratio of the second extraction system to the iron-removed phosphoric acid of step (1) in step (2) is (4-6):1, which further improves the efficient and selective stepwise extraction of iron ions and aluminum ions from the wet-process phosphoric acid. If the volume ratio of the first extraction system to the wet-process phosphoric acid in step (1) is overly low, the extraction cost will increase and the distribution ratio of iron-ion extraction will be reduced; if the volume ratio of the first extraction system to the wet-process phosphoric acid in step (1) is overly high, iron ions and aluminum ions will be both extracted from the wet-process phosphoric acid at the same time, leading to failure in recycling iron and aluminum ions separately. If the volume ratio of the second extraction system to the iron-removed phosphoric acid of step (1) in step (2) is overly low, the extraction of aluminum ions from the iron-removed phosphoric acid will be insufficient, resulting in a decrease in the extraction rate of aluminum ions; if the volume ratio of the second extraction system to the iron-removed phosphoric acid of step (1) in step (2) is overly high, the extraction rate of aluminum ions will not be significantly improved.

Preferably, by mass percentage, a content of iron ions in the wet-process phosphoric acid of step (1) is 0.10-0.50 wt %, which may be, for example, 0.10 wt %, 0.15 wt %, 0.20 wt %, 0.25 wt %, 0.30 wt %, 0.35 wt %, 0.40 wt %, 0.45 wt %, or 0.50 wt %.

Preferably, by mass percentage, a content of aluminum ions in the wet-process phosphoric acid of step (1) is 0.60-3.0 wt %, which may be, for example, 0.60 wt %, 1.0 wt %, 1.5 wt %, 2.0 wt %, 2.5 wt %, or 3.0 wt %.

Preferably, the extractant containing phosphorus-oxygen double bonds comprises any one or a combination of at least two of trialkylphosphine oxide, tributyl phosphate, Cyanex 272, di(1-methylheptyl) methyl phosphonate, or 2-ethylhexyl diphenyl phosphate; wherein a typical but non-limiting combination comprises a combination of trialkylphosphine oxide and tributyl phosphate, a combination of trialkylphosphine oxide and di(1-methylheptyl) methyl phosphonate, or a combination of Cyanex 272 and 2-ethylhexyl diphenyl phosphate.

Preferably, the extractant containing phosphorus-hydroxyl groups comprises bis(2-ethylhexyl) phosphate and/or 2-ethylhexyl (2-ethylhexyl)phosphonate. Preferably, the first extraction system in step (1) further comprises a first diluent.

Preferably, a volume ratio of the extractant to the first diluent in the first extraction system is 1:(1-4), which may be, for example, 1:1, 1:1.5, 1:2, 1:2.5, 1:3, 1:3.5, or 1:4, and preferably, 1:(1-2).

Preferably, the second extraction system in step (2) further comprises a second diluent.

Preferably, a volume ratio of the extractant to the second diluent in the second extraction system is 1:(1-4), which may be, for example, 1:1, 1:1.5, 1:2, 1:2.5, 1:3, 1:3.5, or 1:4.

Preferably, the first diluent and the second diluent each independently comprise any one or a combination of at least two of kerosene, sulfonated kerosene, cyclohexane, xylene, n-heptane, or ethyl acetate; wherein a typical but non-limiting combination comprises a combination of sulfonated kerosene and cyclohexane, a combination of kerosene and cyclohexane, or a combination of sulfonated kerosene and ethyl acetate.

Preferably, the first extraction in step (1) is performed at a temperature of 20-50 °C, which may be, for example, 20 °C, 25 °C, 30 °C, 35 °C, 40 °C, 45 °C, or 50 °C.

Preferably, the first extraction in step (1) is performed for a period of 5-30 min, which may be, for example, 5 min, 10 min, 15 min, 20 min, 25 min, or 30 min.

Preferably, the first extraction process in step (1) is accompanied by a first stirring.

Preferably, the first stirring is performed at a rate of 50-200 r/min, which may be, for example, 50 r/min, 80 r/min, 100 r/min, 120 r/min, 150 r/min, 180 r/min, or 200 r/min, and preferably, 100-180 r/min.

Preferably, the second extraction in step (2) is performed at a temperature of 20-90 °C, which may be, for example, 20 °C, 30 °C, 40 °C, 50 °C, 60 °C, 70 °C, 80 °C, or 90 °C, and preferably, 60-90 °C.

In the present application, the preferred temperature of the second extraction is 60-90 °C, which is beneficial to the extraction of aluminum ions from the iron-removed phosphoric acid; if the temperature of the second extraction is overly low, the aluminum ion extraction rate will decrease; if the temperature of the second extraction is overly high, there won't be significant improvement on the extraction efficiency but a consequence of high energy consumption.

Preferably, the second extraction in step (2) is performed for a period of 5-60 min, which may be, for example, 5 min, 10 min, 20 min, 30 min, 40 min, 50 min, or 60 min.

Preferably, the second extraction process in step (2) is accompanied by a second stirring.

Preferably, the second stirring is performed at a rate of 50-300 r/min, which may be, for example, 50 r/min, 100 r/min, 150 r/min, 200 r/min, 250 r/min, or 300 r/min, and preferably, 200-300 r/min.

In the present application, the preferred second stirring rate during the second extraction process is 200-300 r/min, which is conducive to full mixing of the second extraction system and the iron-removed phosphoric acid, thereby improving the extraction effect of aluminum ions.

Preferably, the first extraction and the second extraction each independently comprise a single-stage extraction and/or a multi-stage extraction; preferably, the first extraction is a single-stage extraction; preferably, the second extraction is a multi-stage extraction.

Preferably, a number of extraction stages of the multi-stage extraction is 2-5 stages, which may be, for example, 2 stages, 3 stages, 4 stage, or 5 stages.

In the present application, further preferably, the first extraction is a single-stage extraction, and the second extraction is a multi-stage extraction and the number of extraction stages is 2-5 stages, which achieves efficient extraction of iron ions and aluminum ions from wet-process phosphoric acid and ensures low energy consumption for extraction.

Preferably, after the first extraction in step (1), an iron-loaded extractant is further obtained.

Preferably, after the second extraction in step (2), an aluminum-loaded extractant is further obtained.

As a further preferred technical solution of the present application, referring to the Process flow shown in FIG. 1, the method comprises the following steps:
(1) mixing a first extraction system with wet-process phosphoric acid in a volume ratio of 1:(1-6), and performing a first extraction for 5-30 min under conditions of 20-50 °C and a first stirring rate of 50-200 r/min, to obtain an iron-removed phosphoric acid and an iron-loaded extractant; and
(2) mixing a second extraction system with the iron-removed phosphoric acid of step (1) in a volume ratio of (1.2-6):1, and performing a second extraction for 5-60 min under conditions of 20-90 °C and a second stirring rate of 50-300 r/min, to obtain highly purified phosphoric acid; wherein a content of iron ions in the wet-process phosphoric acid of step (1) is 0.10-0.50 wt %, and a content of aluminum ions is 0.60-3.0 wt %; the first extraction and the second extraction each independently comprise a single-stage extraction and/or a multi-stage extraction, and a number of extraction stages of the multi-stage extraction is 2-5 stages; and
the first extraction system and the second extraction system each independently comprise an extractant containing phosphorus-oxygen double bonds and/or an extractant containing phosphorus-hydroxyl groups; the first extraction system further comprises a first diluent; a volume ratio of the extractant to the first diluent in the first extraction system is 1:(1-4); the second extraction system further comprises a second diluent; and a volume ratio of the extractant to the second diluent in the second extraction system is 1:(1-4).

Optionally, the iron-loaded extractant in step (1) and the aluminum-loaded extractant in step (2) are subjected to procedures such as stripping, separation and purification to further prepare iron products or aluminum products, respectively; the highly purified phosphoric acid is further purified to prepare phosphorus products.

Compared with the prior art, the present application has the following beneficial effects.

(1) In the method for stepwise extraction of iron and aluminum from wet-process phosphoric acid provided by the present application, by selecting the corresponding O/A ratio for each step, the iron ions and aluminum ions are extracted from wet-process phosphoric acid efficiently in separate steps, thereby facilitating the subsequent separate recovery of iron ions and aluminum ions in wet-process phosphoric acid and the high-quality utilization of wet-process phosphoric acid, and the method has a simple process flow, low cost, and good industrialization feasibility.

(2) In the method for stepwise extraction of iron and aluminum from wet-process phosphoric acid provided by the present application, by further optimizing the process parameters such as the O/A ratio of the first extraction and the second extraction, extraction temperature, extraction time, extraction stages, and the stirring rate during the extraction process, the extraction rates of iron ions and aluminum ions from wet-process phosphoric acid are further improved. The extraction rate of iron ions can reach 99% or more, and the extraction rate of aluminum ions can reach 88% or more.

### BRIEF DESCRIPTION OF DRAWINGS

FIG. 1 is a process flow diagram of the method for stepwise extraction of iron and aluminum from wet-process phosphoric acid provided by the present application.

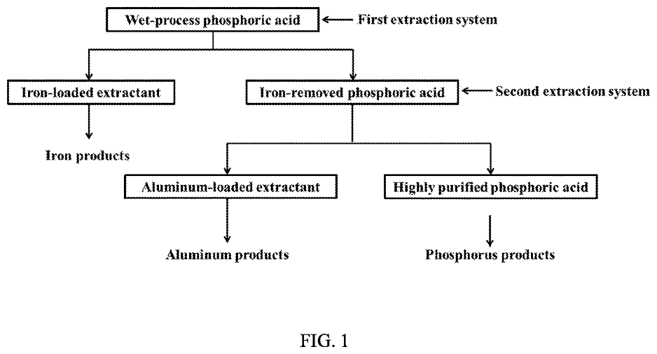

### DETAILED DESCRIPTION

The technical solutions of the present application are further illustrated through specific embodiments below. However, the following examples are merely simple illustrations of the present application and do not represent or define the protection scope of the present application. The protection scope of the present application shall be subject to the claims.

The wet-process phosphoric acid used in the following Examples and Comparative Examples was from Yichang Xingfa Chemical Group Co., Ltd. The wet-process phosphoric acid comprises components listed in Table 1 and water as the remainder.

TABLE 1

| Component | Fe | Al | Mg | Si | P₂O₅ |
|---|---|---|---|---|---|
| Content/wt % | 0.205 | 0.838 | 0.644 | 0.118 | 35.573 |

### I. EXAMPLES

### Example 1

This example provides a method for stepwise extraction of iron and aluminum from wet-process phosphoric acid, and the method comprises the following steps:
(1) a first extraction system and the wet-process phosphoric acid were mixed in a volume ratio of 1:1, and a first extraction was performed for 25 min under conditions of 30 °C and a first stirring rate of 150 r/min, giving an iron-removed phosphoric acid and an iron-loaded extractant; the first extraction was a single-stage extraction; and
(2) a second extraction system and the iron-removed phosphoric acid of step (1) were mixed in a volume ratio of 5:1, and a second extraction was performed for 50 min under conditions of 70 °C and a second stirring rate of 250 r/min, giving highly purified phosphoric acid and an aluminum-loaded extractant; the second extraction was a multi-stage extraction, and a number of the extraction stages were 5 stages;
wherein the first extraction system was prepared by a di(1-methylheptyl) methyl phosphonate extractant and a sulfonated kerosene diluent in a volume ratio of 1:1; and
the second extraction system was the same as the first extraction system.

### Example 2

This example provides a method for stepwise extraction of iron and aluminum from wet-process phosphoric acid, and the method comprises the following steps:
(1) a first extraction system and the wet-process phosphoric acid were mixed in a volume ratio of 1:1.5, and a first extraction was performed for 25 min under conditions of 30 °C and a first stirring rate of 150 r/min, giving an iron-removed phosphoric acid and an iron-loaded extractant; the first extraction was a single-stage extraction; and
(2) a second extraction system and the iron-removed phosphoric acid of step (1) were mixed in a volume ratio of 5:1, and a second extraction was performed for 50 min under conditions of 70 °C and a second stirring rate of 250 r/min, giving highly purified phosphoric acid and an aluminum-loaded extractant; the second extraction was a multi-stage extraction, and a number of the extraction stages were 5 stages;
wherein the first extraction system was prepared by a di(1-methylheptyl) methyl phosphonate extractant and a sulfonated kerosene diluent in a volume ratio of 1:1; and
the second extraction system was the same as the first extraction system.

### Example 3

This example provides a method for stepwise extraction of iron and aluminum from wet-process phosphoric acid, and the method comprises the following steps:
(1) a first extraction system and the wet-process phosphoric acid were mixed in a volume ratio of 1:3, and a first extraction was performed for 20 min under conditions of 20 °C and a first stirring rate of 180 r/min, giving an iron-removed phosphoric acid and an iron-loaded extractant; the first extraction was a single-stage extraction; and
(2) a second extraction system and the iron-removed phosphoric acid of step (1) were mixed in a volume ratio of 4:1, and a second extraction was performed for 40 min under conditions of 90 °C and a second stirring rate of 200 r/min, giving highly purified phosphoric acid and an aluminum-loaded extractant; the second extraction was a multi-stage extraction, and a number of the extraction stages were 5 stages;
wherein the first extraction system was prepared by a 2-ethylhexyl diphenyl phosphate extractant and a sulfonated kerosene diluent in a volume ratio of 1:1.5; and
the second extraction system was the same as the first extraction system.

### Example 4

This example provides a method for stepwise extraction of iron and aluminum from wet-process phosphoric acid, and the method is the same as Example 1 except that in step (1), the volume ratio of the first extraction system to the wet-process phosphoric acid was 1:0.5.

### Example 5

This example provides a method for stepwise extraction of iron and aluminum from wet-process phosphoric acid, and the method is the same as Example 1 except that in step (1), the volume ratio of the first extraction system to the wet-process phosphoric acid was 1:3.5.

### Example 6

This example provides a method for stepwise extraction of iron and aluminum from wet-process phosphoric acid, and the method is the same as Example 1 except that in step (2), the volume ratio of the second extraction system to the iron-removed phosphoric acid of step (1) was 3.5:1.

### Example 7

This example provides a method for stepwise extraction of iron and aluminum from wet-process phosphoric acid, and the method is the same as Example 1 except that in step (2), the volume ratio of the second extraction system to the iron-removed phosphoric acid of step (1) was 6.5:1.

### Example 8

This example provides a method for stepwise extraction of iron and aluminum from wet-process phosphoric acid, and the method is the same as Example 1 except that in the first extraction system, the volume ratio of the di(1-methylheptyl) methyl phosphonate extractant to the sulfonated kerosene diluent was 1:2.

### Example 9

This example provides a method for stepwise extraction of iron and aluminum from wet-process phosphoric acid, and the method is the same as Example 1 except that the second stirring rate during the second extraction was 180 r/min.

### Example 10

This example provides a method for stepwise extraction of iron and aluminum from wet-process phosphoric acid, and the method is the same as Example 1 except that the second extraction was a single-stage extraction.

### II. COMPARATIVE EXAMPLES

### Comparative Example 1

This comparative Example provides a method for extraction of iron and aluminum from wet-process phosphoric acid, and the method is the same as Example 1 except that the volume ratio of the first extraction system to the wet-process phosphoric acid was 5:1.

### Comparative Example 2

This comparative Example provides a method for extraction of iron and aluminum from wet-process phosphoric acid, and the method is the same as Example 1 except that the volume ratio of the second extraction system to the iron-removed phosphoric acid was 1:1.

### III. TESTS AND RESULTS

The extraction rates of iron ions and aluminum ions in the methods provided by the above Examples and Comparative Examples were tested and calculated, and the results are as shown in Table 2.

TABLE 2

| | | Aluminum | | Aluminum |
|---|---|---|---|---|
| | | content of | | content of |
| | Extraction | iron-removed | Extraction | highly purified |
| | rate of | phosphoric | rate of | phosphoric_acid/ |
| Item | Fe³⁺/% | acid/wt % | Al³⁺/% | wt % |
| Example 1 | 99.98 | 0.799 | 88.01 | 0.096 |
| Example 2 | 99.96 | 0.801 | 87.79 | 0.097 |
| Example 3 | 95.31 | 0.831 | 85.90 | 0.117 |
| Example 4 | 99.95 | 0.686 | 87.59 | 0.085 |
| Example 5 | 65.02 | 0.835 | 87.78 | 0.102 |
| Example 6 | 99.85 | 0.828 | 70.51 | 0.244 |
| Example 7 | 99.90 | 0.830 | 88.24 | 0.093 |
| Example 8 | 81.24 | 0.826 | 70.25 | 0.246 |
| Example 9 | 99.84 | 0.826 | 84.22 | 0.130 |
| Example 10 | 99.91 | 0.826 | 46.19 | 0.444 |
| Comparative | 99.98 | 0.468 | 82.12 | 0.084 |
| Example 1 | | | | |
| Comparative | 99.95 | 0.820 | 28.37 | 0.587 |
| Example 2 | | | | |

As can be seen from Table 2

It can be seen from Examples 1 to 3 that by adjusting the O/A ratio of the first extraction and the second extraction in the present application, iron ions can be extracted from wet-process phosphoric acid under a lower O/A ratio, and then aluminum ions can be further extracted from the iron-removed phosphoric acid under a higher O/A ratio, thus achieving the stepwise extraction of iron ions and aluminum ions from wet-process phosphoric acid, and the extraction rate of iron ions is as high as 95.31% or more, and the extraction rate of aluminum ions is as high as 85.90% or more; the method enables separate recovery of aluminum ions and iron ions which have similar properties, and is beneficial to the subsequent high-quality utilization of the highly purified phosphoric acid.

(2) It can be seen from Example 1 and Examples 4 to 7 that due to the high volume ratio of the first extraction system to the wet-process phosphoric acid in Example 4, iron ions and aluminum ions are extracted at the same time from the wet-process phosphoric acid during the first extraction process in step (1), and thereby, the separate recovery cannot be achieved; the volume ratio of the first extraction system to the wet-process phosphoric acid in Example 5 is low, resulting in the extraction rate of iron ions reducing to 65.02%, and there are still iron ions remaining in the iron-removed phosphoric acid; the volume ratio of the second extraction system to the iron-removed phosphoric acid in Example 6 is low, resulting in incomplete extraction of aluminum ions, and the extraction rate of aluminum ions decreases to 70.51%; the volume ratio of the second extraction system to the iron-removed phosphoric acid in Example 7 is relatively high, the extraction effect of aluminum ions is not significantly improved, but the extractant is wasted; it can be seen that in the present application, the volume ratio of the first extraction system to wet-process phosphoric acid is further optimized to be 1:(1-3), and the volume ratio of the second extraction system to the iron-removed phosphoric acid is optimized to be (4-6):1; the synergistic arrangement further improves the efficient extraction and selective separation and recovery of iron ions and aluminum ions from wet-process phosphoric acid.
(3) It can be seen from Example 1 and Example 8 that due to the large proportion of diluent in the first extraction system in Example 8, the extraction effect of iron ions becomes poor, which is only 81.24%, and some iron ions still remain. In the present application, the volume ratio of the extractant to the diluent in the first extraction system is further optimized to be 1:(0.5-1.5), which further improves the extraction effect of iron ions and aluminum ions in wet-process phosphoric acid.
(4) It can be seen from Example 1 and Examples 9 to 10 that the second stirring rate in the second extraction process in Example 9 is low, and the extraction rate of aluminum ions is reduced to 84.22%; the second extraction in Example 10 is a single-stage extraction, resulting in a poor extraction effect of aluminum ions, which is reduced to 46.19%. It can be seen that in the present application, the optimized extraction temperature, stirring rate, and extraction stages in the second extraction process further improve the extraction rate of aluminum ions in wet-process phosphoric acid.
(5) It can be seen from Example 1 and Comparative Examples 1 to 2 that in Comparative Example 1, the first extraction and the second extraction are both performed under a large O/A ratio, resulting in the extraction of both iron ions and aluminum ions during the first extraction process, and iron ions and aluminum ions cannot be separately extracted and recovered from wet-process phosphoric acid; in Comparative Example 2, the first extraction and the second extraction are both performed under a small O/A ratio, resulting in insufficient extraction of aluminum ions or almost no extraction of aluminum ions during the second extraction process, and the recovery and reuse of aluminum ions in wet-process phosphoric acid cannot be realized.

The applicant declares that the above description is merely specific embodiments of the present application, but the protection scope of the present application is not limited thereto. Person skilled in the art should understand that any changes or substitutions easily conceived by those skilled in the art within the technical scope disclosed by the present application shall fall within the protection scope and disclosure scope of the present application.

1. A method for stepwise extraction of iron and aluminum from wet-process phosphoric acid, which comprises the following steps:
(1) mixing a first extraction system with wet-process phosphoric acid in a volume ratio of 1:(1-6), and performing a first extraction to obtain an iron-removed phosphoric acid; and
(2) mixing a second extraction system with the iron-removed phosphoric acid of step (1) in a volume ratio of (1.2-6):1, and performing a second extraction to obtain highly purified phosphoric acid;
wherein the first extraction system and the second extraction system each independently comprise an extractant containing phosphorus-oxygen double bonds and/or an extractant containing phosphorus-hydroxyl groups.

2. The method according to claim 1, wherein in step (1), the volume ratio of the first extraction system to the wet-process phosphoric acid is 1:(1-3).

3. The method according to claim 1, wherein in step (2), the volume ratio of the second extraction system to the iron-removed phosphoric acid of step (1) is (4-6):1.

4. The method according to claim 1, wherein by mass percentage, a content of iron ions in the wet-process phosphoric acid of step (1) is 0.10-0.50 wt %
by mass percentage, a content of aluminum ions in the wet-process phosphoric acid of step (1) is 0.60-3.0 wt %.

5. (canceled)

6. The method according to claim 1, wherein the extractant containing phosphorus-oxygen double bonds comprises any one or a combination of at least two of trialkylphosphine oxide, tributyl phosphate, Cyanex 272, di(1-methylheptyl) methyl phosphonate, or 2-ethylhexyl diphenyl phosphate.

7. The method according to claim 1, wherein the extractant containing phosphorus-hydroxyl groups comprises bis(2-ethylhexyl) phosphate and/or 2-ethylhexyl (2-ethylhexyl)phosphonate.

8. The method according to claim 1, wherein the first extraction system in step (1) further comprises a first diluent
a volume ratio of the extractant to the first diluent in the first extraction system is 1:(1-4).

9. (canceled)

10. The method according to claim 8, wherein the volume ratio of the extractant to the first diluent in the first extraction system is 1:(1-2).

11. The method according to claim 8, wherein the second extraction system in step (2) further comprises a second diluent
a volume ratio of the extractant to the second diluent in the second extraction system is 1:(1-4).

12. (canceled)

13. The method according to claim 11, wherein the first diluent and the second diluent each independently comprise any one or a combination of at least two of kerosene, sulfonated kerosene, cyclohexane, xylene, n-heptane, or ethyl acetate.

14. The method according to claim 1, wherein the first extraction in step (1) is performed at a temperature of 20-50 °C
the first extraction in step (1) is performed for a period of 5-30 min;
the first extraction in step (1) is accompanied by a first stirring at a rate of 50-200 r/min.

15. (canceled)

16. (canceled)

17. (canceled)

18. The method according to claim 14, wherein the first stirring is performed at a rate of 100-180 r/min.

19. The method according to claim 1, wherein the second extraction in step (2) is performed at a temperature of 20-90 °C
the second extraction in step (2) is performed for a period of 5-60 min;
the second extraction in step (2) is accompanied by a second stirring at 50-300 r/min.

20. The method according to claim 19, wherein the second extraction in step (2) is performed at a temperature of 60-90 °C.

21. (canceled)

22. (canceled)

23. (canceled)

24. The method according to claim 19, wherein the second stirring is performed at a rate of 200-300 r/min.

25. The method according to claim 11, wherein the first extraction and the second extraction each independently comprise a single-stage extraction and/or a multi-stage extraction.

26. The method according to claim 25, wherein the first extraction is a single-stage extraction.

27. The method according to claim 25, wherein the second extraction is a multi-stage extraction of 2-5 stages.

28. (canceled)

29. The method according to claim 1, wherein after the first extraction in step (1), an iron-loaded extractant is further obtained
after the second extraction in step (2), an aluminum-loaded extractant is further obtained.

30. (canceled)

31. The method according to claim 1, wherein the method comprises the following steps:
(1) mixing a first extraction system with wet-process phosphoric acid in a volume ratio of 1:(1-6), and performing a first extraction for 5-30 min under conditions of 20-50 °C and a first stirring rate of 50-200 r/min, to obtain an iron-removed phosphoric acid and an iron-loaded extractant; and
(2) mixing a second extraction system with the iron-removed phosphoric acid of step (1) in a volume ratio of (1.2-6):1, and performing a second extraction for 5-60 min under conditions of 20-90 °C and a second stirring rate of 50-300 r/min, to obtain highly purified phosphoric acid and an aluminum-loaded extractant;
wherein a content of iron ions in the wet-process phosphoric acid of step (1) is 0.10-0.50 wt %, and a content of aluminum ions is 0.60~3.0 wt %; the first extraction and the second extraction each independently comprise a single-stage extraction and/or a multi-stage extraction, and a number of extraction stages of the multi-stage extraction is 2-5 stages; and
the first extraction system and the second extraction system each independently comprise an extractant containing phosphorus-oxygen double bonds and/or an extractant containing phosphorus-hydroxyl groups; the first extraction system further comprises a first diluent; a volume ratio of the extractant to the first diluent in the first extraction system is 1:(1-4); the second extraction system further comprises a second diluent; and a volume ratio of the extractant to the second diluent in the second extraction system is 1:(1-4).
